(19) United States
(12) Patent Application Publication
(10) Pub. No.: US 2026/0247020 A1
(43) Pub. Date: Aug. 20, 2026

(54) METHOD AND SYSTEM FOR ACQUIRING IMAGES OF A PENALTY KICK OR A PENALTY SHOOTOUT ON A FOOTBALL FIELD

(71) Applicant: FG18 S.R.L., Pavia (IT)

(72) Inventor: Francesco GULLO, Voghera (PV) (IT)

(73) Assignee: FG18 S.R.L., Pavia (IT)

(21) Appl. No.: 19/161,283

(22) PCT Filed: Oct. 23, 2023
(86) PCT No.: PCT/IB2023/060684

§ 371 Date: Sep. 1, 2025

(30) Foreign Application Priority Data
Mar. 1, 2023 (IT) 102023000003726

(51) Int. Cl. H04N 23/57; A63B 24/00; A63B 71/02; A63B 71/06; H04N 23/51; H04N 23/68

(52) U.S. Cl. CPC H04N 23/57; A63B 24/0021; A63B 71/02; A63B 71/0619; H04N 23/51; H04N 23/685; A63B 2024/0031; A63B 2220/806; A63B 2243/0025

(57) ABSTRACT

A method for acquiring images of a penalty kick or of a penalty shootout on a football field in which there are defined a penalty area and a penalty arc bordering thereto and a goal in front of the penalty arc. The method includes providing a video-photographic apparatus, burying the video-photographic apparatus, positioning actuation means in a remote location with respect to the video-photographic apparatus, extending the camera above ground level by means of a signal provided by the actuation means, acquiring images of the game on the football field, retracting the camera after the acquisition of the images.

### CROSS-REFERENCE TO RELATED APPLICATIONS

This application is a § 371 national phase of PCT/IB2023/060684, filed Oct. 23, 2023, which claims priority of Italian Patent Application Number 102023000003726, filed Mar. 1, 2023, the entire contents of all of which are incorporated by reference herein as if fully set forth.

### INVENTIVE FIELD

The present invention relates to a structurally and functionally designed method and system for acquiring images of a penalty kick or a penalty shootout on a football field.

### BACKGROUND

Filming a game on a sports field such as a football field in particular presents many challenges.

Effectively filming a game such as a football tournament or an occasional football match may require several cameras with various angles.

However, the cameras must not interfere with the game or the players within the game.

Therefore, the cameras are typically positioned entirely outside the surface of the sports field, as for example described in US 2019/160356 A1 and US 2006/273522 A1. More generally, in television filming of football matches, several dozen cameras are placed around the football field.

This solution has obvious drawbacks. Indeed, the game of football involves activities that take place in relatively large spaces. Effectively acquiring images of these activities can be a challenge when using cameras that are positioned a certain distance away from the game.

In addition, the positioning of the players and the dynamics of the action may obstruct the view of the cameras, hindering filming.

Therefore, the close-ups and shots that can be produced using known systems are not satisfactory.

The aforementioned drawbacks are accentuated by the fact that some stadiums are difficult to “exploit” on television with conventional filming systems.

For example, a well-known filming technique involves the use of a camera mounted on a trolley positioned on a track behind the LED advertising board lines or behind goals. However, this technique is severely limited by the presence, in some stadiums (especially older ones), of an athletics track that, extending around the football field, prevents the director from bringing the cameraman close to the playing action.

In other (smaller) stadiums, there is not enough space to place the cameras, so the broadcasters concerned have to compromise on the number of cameras to be used.

One technology currently in use is also the so-called Spidercam®. This system allows a camera or film camera to move vertically and, simultaneously, horizontally, over a predetermined area.

The system operates with four motorized winches positioned at each of the four corners at the base of the rectangular area defined by the football field, each connected by cables to a gyroscopically stabilized head to which the camera is attached.

While this technology allows for different subjectivities and the ability to film playing action close up, it requires a complex structure that can therefore only be used in very high-level contexts.

In addition, it only allows shots from above, thus not allowing details of the ball and shooting gestures to be appreciated.

It would therefore be desirable to improve the effectiveness and versatility of known systems for filming football matches and, more generally, for acquiring images of the game on a football field.

However, beyond television footage, the need to acquire images of the game on the football field also stems from the problem of verifying the validity of goals and reducing ghost goal incidents.

For this latter purpose, it is known to employ so-called “goal-line technology”, which uses fourteen high-speed cameras mounted on the stadium walkway (seven cameras for each goal). Through a sensor embedded in the ball, these cameras follow the movements of the ball and triangulate its position, using multiple viewpoints to improve accuracy. If the ball crosses the goal line, a message is sent to the receiver that the referee is wearing on his wrist, informing him that the goal is legal.

Although the introduction of goal-line technology represented a significant technical advance, it is not infallible. This was illustrated, for example, by the case of the Aston Villa-Sheffield United match on 17 Jun. 2020, when goal-line technology failed to recognize a goal in favor of the visiting team. The problem, in that case, had been a series of fortuitous events in the positioning of the players and the dynamics of the action, which had prevented the goal-line technology from detecting the goal because all seven cameras involved had their view obstructed.

It would therefore be desirable to be able to acquire images of the game on the football field with greater reliability.

In this regard, it should be noted that in football, unlike other sports, the speed of the game and in particular the speed with which the ball moves across the field can be very high.

In the case of a kick or penalty shootout, for example, the speed of the ball is typically at least 100 km/h and in some cases can approach or even exceed 200 km/h.

Therefore, tracking systems designed to acquire images of moving objects at low speeds, or in different sports disciplines, such as the solutions described in CN 213 656 260 U, SG 185 164 A1 or WO 2022/225899 A1, are of no use for filming the game on a football field.

### DESCRIPTION OF THE INVENTION

The problem underlying the present invention is to provide a method and a system for acquiring images of the game on a football field that are structurally and functionally designed to overcome, at least in part, one or more of the drawbacks complained of above with reference to the cited known art.

In this context, an object of the present invention is to make available a method and system for acquiring images of a penalty on a football field without interfering with the game or the players within the game.

An object of the present invention is also to make available to the state of the art a method and system for acquiring close-up images of a penalty during a football match, making it possible to appreciate the technical gesture of the footballer.

Furthermore, it is an object of the present invention to make available to the state of the art a method and system for acquiring images of a penalty with less visual obstruction.

### SUMMARY

This problem is solved, and at least one of these objects is achieved, at least in part, by the invention in a first aspect by means of a method for acquiring images of a penalty kick or a penalty shootout on a football field, wherein there are defined a penalty area, a penalty arc bordering thereto and a goal in front of the penalty arc, comprising one or more of the following steps:
(a) providing a video-photographic apparatus including a casing, a camera associated with said casing and a cover configured to reversibly close the opening;
(b) burying said video-photographic apparatus in the playing field, preferably in the penalty area or in an area adjacent thereto, even more preferably in the penalty arc bordering the penalty area in such a way that it is positioned below the ground level of the football field;
(c) directing said camera of said video-photographic apparatus towards the goal in front of the penalty area and/or the penalty arc;
(d) positioning actuation means in a remote location with respect to said video-photographic apparatus;
(e) operatively connecting said actuation means with said video-photographic apparatus;
(f) lifting said cover and extending said camera above the ground level in response to a remotely controlled actuation of said actuation means;
(g) acquiring game images on the football field by means of said camera;
(h) retracting the camera below the ground level and closing said cover after acquiring said images of the game.

It will be appreciated that the method according to the invention allows the video-photographic apparatus to be placed in close proximity to the playing action and remotely activated to acquire close-up game images without interfering with the game or the players within the game. Furthermore, the positioning of the camera allows the playing action to be filmed while minimizing the risk that the view may be obstructed by the presence of the players.

Unless specified otherwise, the above steps can be performed in any order. The recitation of identifiers such as (a), (b), (c), (d), (e), (f), (g), (h) before the steps does not specify a particular order of the steps, but rather is used to simplify subsequent reference to these steps.

It should be noted that, in this context, the term “images” preferably refers to both still and video images. Therefore, if it is indicated that the camera acquires “images”, it means that the camera can acquire both still and video images (which may include a plurality of successive still images).

In addition, the term “remote location” referring to the position of the actuation means in relation to the video camera equipment, is understood to mean a location preferably located at a certain distance from the video-photographic apparatus, in particular a sufficient distance so that the actuation means do not interfere with the game acquired by the camera images. For this purpose, it is preferable for the remote location to be outside the playing area of the football field or possibly close to a line delimiting the playing ground.

In a second aspect, the invention relates to a system for acquiring images of the game on a football field comprising video-photographic apparatus.

The video-photographic apparatus preferably includes a casing that can be buried in a football field and a camera.

Preferably, the camera is associated with the casing movably through an opening in the casing.

Preferably, the apparatus also comprises movement means configured to move the camera through said opening between a retracted position in which the camera is arranged inside the casing and an extended position in which the camera extends at least partially outside the casing to acquire game images on the football field.

Preferably, the apparatus also comprises a control unit associated with the movement equipment to drive it.

The system may include actuation means that are positionable at a distance with respect to the video-photographic apparatus.

Preferably, the actuation means are operatively connected to the control unit and actuatable with remote control to move the camera by means of the movement means between the extended position and the retracted position.

It will therefore be appreciated that the method and system of the present invention allow for the filming of activities on the football field while minimizing view obstructions from a close-up shot in order to facilitate an enhanced viewing experience through, for example, a broadcast of a football event on television.

In a third aspect, the invention also relates to a method for acquiring images of the game on a sports field comprising one or more of the following steps:
(a) positioning a video-photographic apparatus below the ground level of a sports field;
(b) positioning actuation means in a remote location with respect to said video-photographic apparatus;
(c) operatively connecting said actuation means with said video-photographic apparatus;
(d) extending a camera of said video-photographic apparatus above the ground level in response to a remotely controlled actuation of said actuation means;
(e) acquiring game images on the sports field by means of said camera;
(f) retracting the camera below the ground level after (e).

It will be appreciated that the method according to the invention allows the video-photographic apparatus to be placed in close proximity to the playing action and remotely activated to acquire close-up game images without interfering with the game or the players within the game. Furthermore, the positioning of the camera allows the playing action to be filmed while minimizing the risk that the view may be obstructed by the presence of the players.

In a fourth aspect, the invention relates to a system for acquiring images of the game on a sports field comprising video-photographic apparatus.

The video-photographic apparatus preferably includes a casing that can be buried in a sports field and a camera.

Preferably, the camera is associated with the casing movably through an opening in the casing.

Preferably, the apparatus also comprises movement means configured to move the camera through said opening between a retracted position in which the camera is arranged inside the casing and an extended position in which the camera extends at least partially outside the casing to acquire game images on the sports field.

Preferably, the apparatus also comprises a control unit associated with the movement equipment to drive it.

The system may include actuation means that are positionable at a distance with respect to the video-photographic apparatus.

Preferably, the actuation means are operatively connected to the control unit and actuatable with remote control to move the camera by means of the movement means between the extended position and the retracted position.

It will therefore be appreciated that the method and system of the present invention allow for the filming of activities on the sports field while minimizing view obstructions from a close-up shot in order to facilitate an enhanced viewing experience through, for example, a broadcast of a football event on television.

The present invention in at least one of the above-mentioned aspects may also have one or more of the following preferred features in addition to those previously mentioned.

For example, the video-photographic apparatus may comprise releasable coupling means by which the camera is removably coupled to its casing. This makes it possible to remove the camera at the end of the game.

Again, by way of example, the method may comprise acquiring said game images and/or retracting said camera in response to a remotely controlled actuation of the actuation means.

It is preferred that the video-photographic apparatus comprises movement means operatively connected to the actuation means. Further preferred is that the extension of the camera comprises the extension of the camera above the ground level of the football field by means of said movement means in response to the remotely controlled actuation of the actuation means.

Also preferably, positioning the actuation means comprises positioning the actuation means outside the playing ground of the football field or close to a line delimiting the playing ground. In this way, the actuation means do not interfere with the game or the players within the game.

Optionally, the method comprises performing a playing action after extending the camera, wherein said step of acquiring images comprises acquiring images of said playing action by means of the camera.

It should be noted that, in this context, “football field” preferably means the playing surface, i.e., the rectangular area delimited by goal lines and sidelines on which the game is played.

Further preferred is that the playing action includes a shot, more specifically a penalty kick or a penalty shootout.

It should be noted that, in this context, “shot” means the act of flinging a football, in particular with a foot. The shot can be, for example, a shot on goal, i.e. a shot of the ball towards the goal.

Furthermore, it should be noted that the term “penalty kick” preferably refers to a penalty kick within the meaning of Law 14 of the Laws of the Game of Football. Generally, a penalty kick is therefore a shot taken against the opponent's goal defended by the goalkeeper alone, awarded to the team that has suffered a serious foul in the penalty area.

The term “penalty shootout”, on the other hand, preferably refers to a penalty shootout within the meaning of Law 10 of the Laws of the Game of Football. Generally, a penalty shootout is therefore a shot taken to determine the winning team in a football match that ended in a draw.

Hereafter, for the sake of brevity, the term “penalty” may be used to refer indistinctly to both the penalty kick and the penalty shootout.

In some embodiments, it is intended to detect a goal on the basis of the images acquired in said acquisition and possibly notify said goal in response to said detection. This feature makes it possible to check the validity of goals and reduce the occurrence of ghost goals.

Of course, in some embodiments the playing action may include an action other than a shot. For example, depending on the circumstances, the playing action may include a player celebrating after a goal.

In a manner of speaking, the football field preferably comprises a penalty area in which the action of the game, in particular the penalty kick or shootout, can take place, and preferably also a penalty arc bordering onto the penalty area.

It should be noted that, in this context, “penalty area” preferably means the rectangular area located in front of each goal and within which the goalkeeper of the defending team may touch and hold the ball with his hands.

The term “penalty arc”, on the other hand, preferably refers to the area between the penalty area and the penalty arc of a circle that is present outside the penalty area and that delimits the minimum distance for players from the penalty spot during a penalty kick or shootout.

In order to film the penalty kick or shootout, it is preferred that said positioning of the video-photographic apparatus comprises placing or rather burying the video-photographic apparatus in the penalty arc bordering onto the penalty area. In this regard, it should be noted that this positioning is particularly advantageous because by regulation during the penalty kick action, it is forbidden for any player, of either team, to enter the penalty area, and this guarantees the feasibility and safety of positioning the apparatus in the penalty arc.

It is further preferred that the camera faces the goal in front of the penalty arc. In this way, the camera can provide a close-up of the playing action in the penalty area and in particular at the penalty spot, which, according to the regulations, is generally 11 meters from the goal line. For this purpose, the camera preferably has a viewing angle sufficient to frame at least partially and preferably the entire goal area in front of the penalty arc or at least the corresponding goal.

These features allow the camera to offer close-up shots of the playing action and in particular of the ball and the footballer's shoe during the shot. Advantageously, the quality of the camera shots is such that advertising logos that are typically placed on the ball and/or shoe can be clearly identified.

To further enhance these camera shots, it is preferable to reproduce the images of the playing action in a graphic representation comprising the display of supplementary information related to the playing action.

In embodiments, the video-photographic apparatus comprises a cover to cover the camera. More specifically, the equipment casing may comprise a cover configured to reversibly close the opening when the camera switches from the extended position to the retracted position.

In a preferred embodiment, the casing comprises a box-like body to which said cover is hinged. This allows the cover to be moved in a simple and particularly resistant manner.

It is preferred for said extending the camera to comprise raising said cover above the ground level of the football field in response to the remotely controlled actuation. It is further preferred for said retracting the camera to comprise lowering said cover substantially flush with the ground level of the football field. Note that, in the retracted position, the camera is preferably below the ground level of the field. This way, when the cover is lowered, the camera is protected and does not interfere with the game or the players within the game.

It should be noted that the term “substantially flush” with the cover means that the cover is preferably flush with the ground level or deviates from the ground level by a maximum of 1 cm and even more preferably 5 mm.

Optionally, it is provided to connect the video-photographic apparatus to the actuation means by means of a buried wiring at or substantially in parallel to a pressure conduit of an irrigation system of the football field. This reduces the cost and complexity of connecting the apparatus.

Further preferred aspects are also defined in the appended claims as well as in the following description.

### BRIEF DESCRIPTION OF THE DRAWINGS

The characteristics and advantages of the invention will become clearer from the detailed description that follows of a preferred embodiment example illustrated, by way of non-limiting example, with reference to the appended drawings in which:

FIG. 1 is a perspective view of a video-photographic apparatus realized in accordance with the present invention;

FIG. 2 is a partially exploded view of the apparatus in FIG. 1;

FIG. 3 depicts a portion of the apparatus in FIG. 1 emerging from the ground;

FIGS. 4 and 5 are schematic representations of a football field where the apparatus in FIG. 1 is installed;

FIGS. 6a, 6b are cross-sectional views of a video-photographic apparatus in accordance with a second embodiment of the invention, arranged below and partially above ground level, respectively;

FIG. 7 is a raised view of a variant of the apparatus in FIGS. 6a, 6b;

FIG. 8 are schematic graphic representations of images acquired using the apparatus in the previous figures.

### DETAILED DESCRIPTION OF THE PREFERRED EMBODIMENTS

In the figures, the video-photographic apparatus for acquiring images of the game on a football field 10 is collectively referred to as 1.

The apparatus 1 comprises a casing 20 buried in the football field 10 and a camera 3 movably associated with the casing 20 through an opening 21 in the casing.

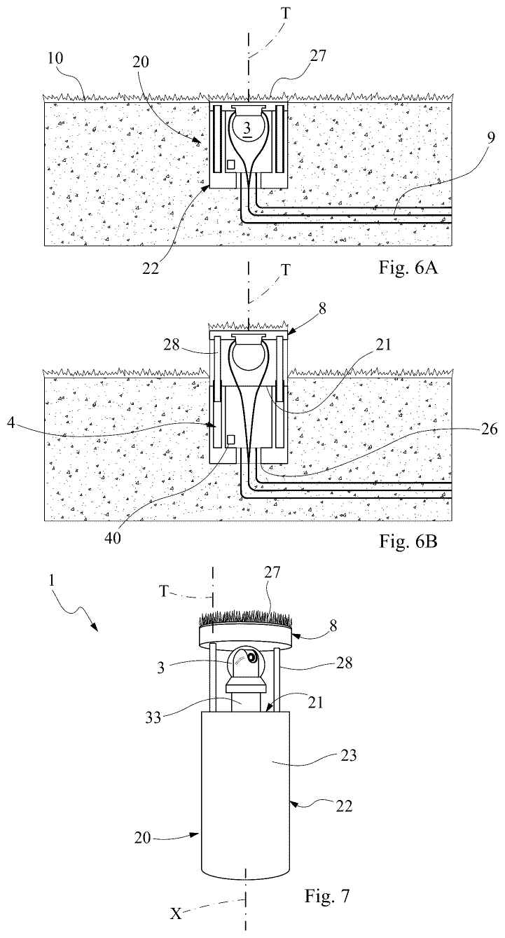

The apparatus 1 further comprises movement means 4 configured to move the camera 3 through said opening 21 between a retracted position in which the camera 3 is arranged inside the casing 20 (example of FIG. 6A) and an extended position in which the camera 3 extends at least partially outside the casing 20 to acquire game images on the football field 10 (example of FIG. 6B).

The apparatus 1 also comprises a control unit 40 associated with the movement means 4 to drive them. The control unit 40 and the movement means 4 are preferably housed in the casing 20 in a protected position.

The casing 20 preferably comprises a box-like body 22 in which the opening 21 for moving the camera 3 is defined. In embodiments, the box-like body 22 extends longitudinally along a direction X and preferably the opening 21 is defined at a longitudinal end of the box-like body 22.

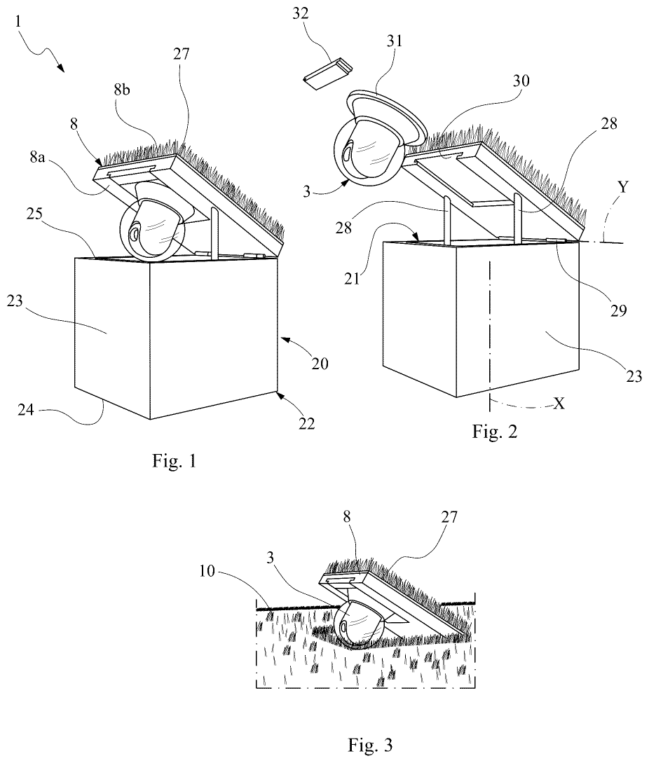

The box-like body 22 may have different shapes but is preferably prismatic, particularly square, as shown in the example in FIG. 1, or cylindrical, as shown in the example in FIG. 7.

In embodiments, the box-like body 22 comprises one or more side walls 23 extending longitudinally from a lower base 24 to an opposing upper base 25. The opening 21 for the movement of the camera 3 is preferably defined at the upper base 25. In addition, at least one secondary opening 26 may be further defined in the box-like body 22, preferably at the lower base 24 and/or side walls 23, for the passage of cables and/or water drainage.

The box-like body 22 is advantageously configured to be buried below the ground level of the football field 10, with the opening 21 facing upwards. In such a configuration, the longitudinal extension direction X of the box-like body 22 is preferably substantially vertical. It should be noted that in this context the term “substantially vertical” referring to a direction is understood to mean that this direction is vertical or deviates from perfect verticality preferably by a maximum of 10 degrees and even more preferably 5 degrees.

When the box-like body 22 is buried in football field 10, the retracted position of the camera 3 is preferably below the ground level of the football field 10, while the extended position of the camera 3 is preferably above the ground level of the football field 10.

Preferably, the casing 20 comprises a cover 8. The cover 8 is advantageously configured to reversibly close the opening 21 when the camera 3 switches from the extended position to the retracted position.

A lower surface 8a facing the box-like body 22 and an opposing upper surface 8b are preferably defined on the cover 8.

A portion of turf 27, synthetic or natural, is preferably applied to the upper surface 8b of the cover in such a way that it can be moved together with the cover 8 when the camera 3 moves between the retracted and the extended positions.

When the casing 20 is buried in the football field 10 and the cover 8 is closed, the upper surface 8b of the cover (including any portion of the turf 27) is preferably arranged substantially flush with the ground level of the football field 10.

In embodiments, the camera 3 is coupled to the lower surface 8a of the cover in such a way that it can be moved together with the cover 8 between the retracted and extended positions.

The movement means 4 may include one or more actuators, e.g. electric or hydraulic, preferably mounted within the casing 20, and possibly one or more guide elements 28. Said one or more actuators may be configured to move the cover 8 together with the camera 3, possibly with the aid of one or more guide elements 28 slidably accommodated in corresponding seats formed in the box-like body 22 and in particular in the side walls 23 thereof.

It is preferred that said one or more guide elements 28 extend along the longitudinal extension direction X of the box-like body 22. Further preferred is that said one or more guide elements 28 are sliding along the same direction X. In embodiments, two mutually spaced guide elements 28 are provided which, in the example of a prismatic box-like body 22, may be associated with respective opposing side walls 23 of the box-like body.

In embodiments, as shown in the example in FIG. 2, the cover 8 is hinged to the box-like body 22 of the casing around a hinge 29. This feature is shown in combination with a prismatic 22 box-like body, but is also suitable for a box-like body of another shape, e.g. cylindrical.

The camera 3 is preferably coupled to the lower surface 8a of the cover in such a way that it can be moved between the retracted and extended position along a penalty arc of a circle centered in the axis Y of said hinge 29. This feature allows for a strong and particularly compact structure.

In embodiments, the hinge 29 is formed at a side wall 23 of the box-like body, preferably in proximity to the opening 21. If the box-like body 22 is prismatic, in particular quadrangular, it is preferable that the side wall 23 on which the hinge 29 is formed is interposed between the side walls with which the guide elements 28 are associated.

The axis Y of the hinge is preferably transverse to the longitudinal extension direction X of the box-like body 22. When the casing 20 is buried in football field 10, the axis Y of the hinge is preferably substantially horizontal. It should be noted that the term “substantially horizontal” referring to the axis Y of the hinge is understood to mean that this axis is horizontal or deviates from perfect horizontality preferably by a maximum of 10 degrees and even more preferably 5 degrees.

In embodiments, the camera 3 is removably coupled to the housing 20, in particular by means of releasable coupling means 30 such as, for example, shape-coupling means, snap-coupling means, threaded coupling means, bayonet coupling means, or pin-coupling means insertable in a respective hole, and the like.

As shown in the example in FIG. 2, the camera 3 can be removably coupled to the lower surface 8a of the cover in such a way that it can be moved together with the cover 8 between the retracted and extended positions. Preferably releasable coupling means 30 are formed on the lower surface 8a of the cover and configured to cooperate with corresponding coupling counter-means 31 formed on the camera 2. For example, a dovetail seat is formed on the lower surface 8a of the cover, and a profile conjugate to that of the seat is preferably formed on the camera 3, or vice versa. To retain the camera 3 in its seat, a releasable stop 32 can be additionally provided.

In embodiments as shown in the examples of FIGS. 6a and 6b, the cover 8 is mounted on the box-like body 22 (prismatic, cylindrical or otherwise shaped) in a translatable manner along a translation direction T. The camera 3 can be coupled to the cover 8 in such a way that it can be moved in translation together with the cover 8 between the retracted position and the extended position.

One or more guide elements 28 may be configured to guide the translation of the lid 8 and, for this purpose, it is preferred that they extend along the translation direction T of the cover with the ability to slide relative to the box-like body 22.

The translation direction T of the cover is preferably substantially parallel to the longitudinal extension direction X of the box-like body. In particular, the term “substantially parallel” referring to two directions is understood to mean that these directions are parallel to each other or deviate from perfect parallelism preferably by a maximum of 10 degrees and even more preferably 5 degrees. When the casing 22 is buried in the football field 10, the translation direction T of the lid is preferably substantially vertical.

With reference to the example in FIG. 7, a movable camera support 33 can be accommodated in the box-like body 22. It is preferred that camera 3 be mounted on the movable support 33 in such a way that it can be moved together with the movable support 33 between the retracted and extended positions. Further preferred is that the movement means 4 is configured to move the movable support 33 together with the camera 3 between the two aforementioned positions. The movement means 4 can be integrated into the movable support 33.

The movable support 33 preferably extends away from the lower base 24 of the box-like body and is preferably movable in translation along the longitudinal extension direction X of the box-like body and/or the translation direction T of the cover.

The camera 3 is preferably removably mounted on the upper face of the movable support 33, i.e. the face facing towards the cover 8. For this purpose releasable coupling means 30 are preferably formed on the upper face of the movable support 33 and configured to cooperate with corresponding coupling countermeans 31 formed on the camera 3.

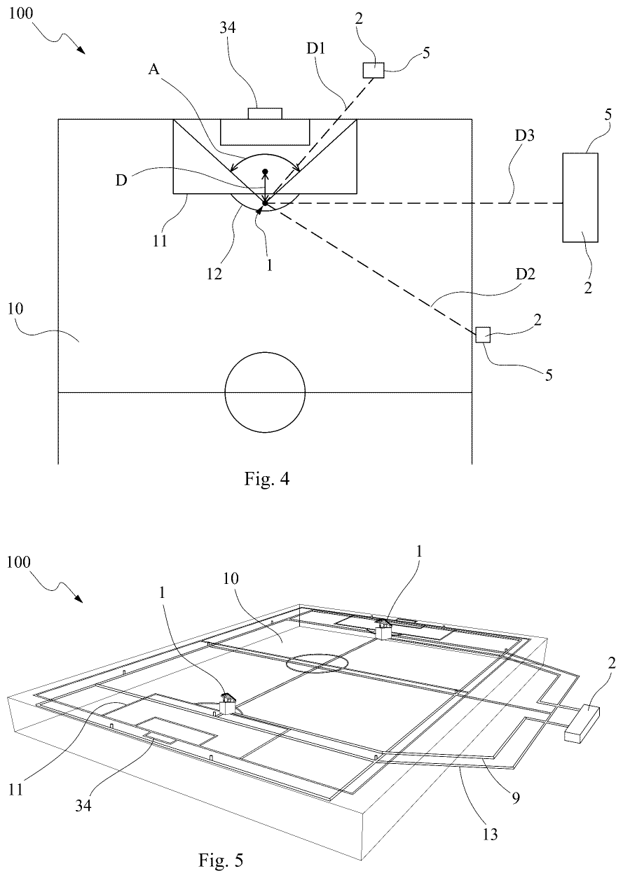

It is preferable to place the apparatus 1 in a football field 10 and in particular below the ground level of the football field. It is also preferable to position or rather bury the apparatus 1 in the penalty arc 12 bordering onto a penalty area 11, as shown in the example in FIG. 4, in particular at a distance D from the penalty point comprised between 5 and 7 meters and preferably 6 meters. Further preferred is that camera 3 has a viewing angle A configured to film the playing action in the penalty area 11. For this purpose, the viewing angle A is preferably at least 50 degrees, even more preferably at least 70 degrees and, in a more preferred example, comprised between 80 degrees and 120 degrees.

In embodiments the apparatus 1 is part of a system 100 for acquiring game images on the football field 10. Preferably, the system 100 comprises the apparatus 1 and actuation means 2 thereof.

Advantageously, the actuation means 2 can be remotely actuated to move the camera 3 by means of the movement means 4 between the extended and retracted positions.

For this purpose, the control unit 40 preferably includes a processor and a memory comprising machine-readable instructions which, when executed by the processor, cause the control unit 40 to implement the remotely controlled actuation provided by the actuation means 2.

The actuation means 2 comprise, for example, a control unit and/or a remote control as well as possibly a screen configured to display the images of the camera 3. In embodiments, the actuation means 2 are integrated into a director's console.

The actuation means 2 are preferably positioned in a remote location 5 with respect to the video-photographic apparatus 1, e.g. at least 15 meters and preferably at least 20 meters from the apparatus 1, so as not to interfere with the game or the players within the game. For this purpose, the actuation means 2 may be positioned outside the playing field or possibly close to a line delimiting the playing field. The example in FIG. 4 shows three possible alternatives for the positioning of the actuation means 4.

A first embodiment envisages that the actuation means 4 are arranged behind the football goal 34 in front of the apparatus 1, at a distance D1 from the apparatus 1 preferably comprised between 20 and 30 meters.

A second embodiment provides that the actuation means 4 are placed at a VAR (Video Assistant Referee) location, at a distance D2 from the apparatus 1 preferably comprised between 20 and 50 meters.

A third embodiment envisages that the actuation means 4 are arranged in a director's console, in particular a director's truck, at a distance D3 from the apparatus 1 preferably comprised between 60 and 100 meters.

Preferably, the actuation means 4 are operatively connected to the control unit 40 of the apparatus 1, in particular by means of wiring 9, as shown in the example in FIG. 5, or alternatively by means of a wireless network.

It is preferred that the apparatus 1 and/or camera 3 comprise one or more connectors for reversible connection to the wiring 9.

The wiring 9 can be arranged for both the data transmission and power supply of the apparatus 1 and, for this purpose, may comprise both a data cable and a power supply cable.

It is preferred that the wiring 9 passes through the secondary opening 26 in the box-like body. Further preferred is that the wiring 9 be buried at or substantially parallel to a pressure conduit 13 of an irrigation system of the football field. For this purpose, it is provided to possibly divert or extend the pressure conduit 13 of an existing irrigation system.

In embodiments, the camera 3 comprises a microphone through which audio can be recorded, particularly during a playing action. Thanks to the proximity between the camera and the playing action, the microphone is able to record the voice of a player involved in the playing action, particularly when cheering or conversing with his teammates, or possibly even the voice of a referee.

The operation of the system 100 is described below.

The apparatus 1 can be actuated on command, in particular when there is a playing action the vicinity thereof.

For example, in the context of a football match, it is provided to actuate the apparatus 1 when a foul occurs, in order to take a penalty kick in the penalty area 11 in front of the apparatus 1.

For this purpose, a remotely controlled actuation is transmitted from the actuation means 4 to the control unit 40 of the apparatus 1, e.g. via the wiring 9.

In response to this actuation, the movement means 4 extend the camera 3 above ground level so that the camera 3 can frame the playing action.

At this point, the camera 3 can acquire images of the game on the football field 10, e.g. images of the penalty kick.

It is then planned to retract the camera 3 below ground level, for example in response to the acquisition of images or, alternatively, in response to an additional remotely controlled actuation.

At the end of the sports event, the camera 3 can be removed from the apparatus 1, so that it can be used in other contexts. Removal is facilitated by the releasable coupling means 30.

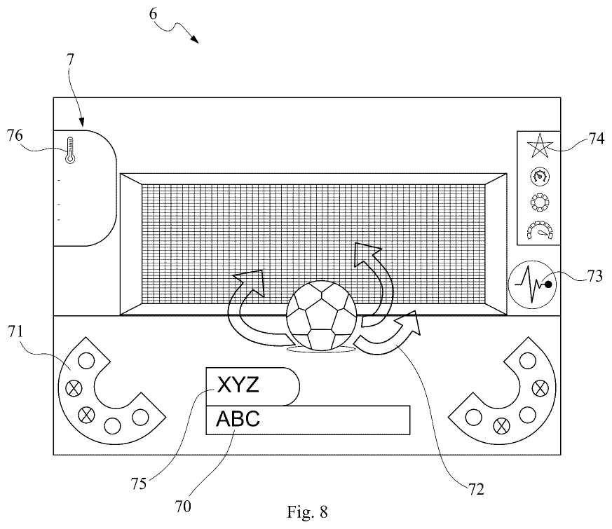

The images acquired by the camera 3 can be broadcast on television, for example, preferably in the context of a graphic representation 6 which, as shown in the example in FIG. 8, comprises the display of supplementary information 7 relating to the playing action.

By way of example, the supplementary information 7 may include a combination of information to be chosen from: player identification information 70, in particular a player involved in the action (e.g. player's name, surname and/or photo as well as career, goals, nationality, right/left foot and/or role if applicable); indicators 71 of a player's achievement percentage (i.e. a percentage of goals compared to the number of shots taken by the player), possibly related to a challenge; directional arrows 72 on the player's historical achievement; player's vital parameters 73 (e.g. heart rate); brand 74 of the shoes worn by the player; team identification information 75, in particular the team to which the player belongs; technical data and/or brand of a ball, in particular the ball used in the playing action; environmental parameters such as temperature 76, humidity and/or wind.

The invention thus achieves the proposed objects while also achieving numerous advantages over the known reference art, including the possibility of acquiring close-up images of the playing action with an unobstructed view, in the context of a simple, rational solution with relatively low implementation costs.

1. A method for acquiring images of a penalty kick or of a penalty shootout on a football field, wherein there are defined a penalty area and a penalty arc bordering thereto and a goal in front of the penalty arc, the method comprising:
providing a video-photographic apparatus including a casing, a camera associated with said casing, an opening for a movement of said camera and a cover configured to reversibly close said opening;
burying said video-photographic apparatus in the penalty arc bordering with the penalty area in such a way that it is positioned below a ground level of the football field;
directing said camera of said video-photographic apparatus towards the goal in front of the penalty arc;
positioning actuation means in a remote location with respect to said video-photographic apparatus;
operatively connecting said actuation means with said video-photographic apparatus;
lifting said cover and extending said camera above the ground level in response to a remotely controlled actuation of said actuation means;
acquiring images of the game during the performance of the penalty kick or of the penalty shootout on the football field by means of said camera;
retracting the camera below the ground level and closing said cover flush with the ground level of the football field after said acquiring of said images of the game.

2. The method according to claim 1, wherein said video-photographic apparatus comprises movement means operatively connected to said actuation means, wherein said extending of said camera comprises the extension of the camera above the ground level of the football field by means of said movement means in response to the remotely controlled actuation of the actuation means.

3. The method according to claim 1, further comprising performing a penalty kick or a penalty shootout after said lifting said cover and extending said camera.

4. The method according to claim 3, wherein said acquiring images of the game during the performance of the penalty kick or penalty shootout comprises acquiring images of a ball on a penalty spot of the penalty area and of a trajectory travelled by said ball between the penalty spot and the goal by means of said camera.

5. The method according to claim 2, further comprising reproducing the images of said penalty kick or penalty shootout in a graphical representation comprising displaying supplementary information relating to said playing action.

6. The method according to claim 1, further comprising connecting said video-photographic apparatus to said actuation means by a wiring buried in the football field.

7. The method according to claim 6, wherein said wiring is buried at or substantially in parallel to a pressure conduit of an irrigation system of the football field.

8. A system for acquiring images of a penalty kick or of a penalty shootout on a football field comprising:
a video-photographic apparatus including a casing that can be buried in a football field, a camera associated with said casing movably through an opening of said casing, movement means configured to move said camera through said opening between a retracted position in which the camera is arranged inside the casing and an extended position in which the camera extends at least partially outside the casing to acquire game images on said football field, and a control unit associated with said movement means to drive them, wherein said casing comprises a cover configured to reversibly close said opening when said camera passes from the extended position to the retracted position;
actuation means positionable at a distance with respect to said video-photographic apparatus, said actuation means being operatively connected to said control unit and actuatable with remote control to move said camera by means of said movement means between said extended position and said retracted position.

9. The system according to claim 8, wherein said video-photographic apparatus comprises releasable coupling means by means of which said camera is removably coupled to said casing.

10. The system according to claim 8, wherein said casing comprises a box-like body to which said cover is hinged.

11. The system according to claim 10, wherein said cover is hinged to said box-like body.

12. The system according to claim 11, wherein said cover is hinged to said box-like body of said casing around a hinge, said camera being preferably coupled to a lower surface of said cover in such a way that it can be moved between the retracted position and the extended position along a penalty arc of a circle substantially centered in an axis of said hinge.

13. The system according to claim 10, wherein said cover is mounted on said box-like body in a translatable manner along a translation direction.

14. The system according to claim 13, wherein said box-like body defines a longitudinal extension direction, said translation direction of said cover being substantially parallel to said longitudinal extension direction.

15. The system according to claim 8, further comprising a portion of turf applied on an upper surface of said cover.

16. A method for acquiring images of the game on a sports field comprising:
providing a video-photographic apparatus including a casing, a camera associated with said casing, an opening through which the camera can pass, and a cover configured to reversibly close the opening;
positioning the video-photographic apparatus below the ground level of a sports field;
positioning a control unit in a remote location with respect to said video-photographic apparatus;
operatively connecting the control unit with the video-photographic apparatus;
lifting the cover of the video-photographic apparatus above the ground level and extending the camera of the video-photographic apparatus above the ground level in response to a remotely controlled actuation of the control unit; acquiring game images on the sports field by the camera;
retracting the camera below the ground level after acquiring game images on the sports field by the camera.

17. The method according to claim 16, further comprising broadcasting images acquired by the camera on television, in the context of a graphic representation, further comprising displaying supplementary information relating to game play.

18. The method according to claim 17, wherein the images broadcasted on television are combined with supplementary information include at least one of: player identification information; indicators of a player's achievement percentage; directional arrows on the player's historical achievement; player's vital parameters; brand of the shoes worn by the player; team identification information; technical data; brand of a ball; environmental parameters; temperature; humidity; or wind.

19. A system for acquiring images comprising a video-photographic apparatus including a casing and a camera, the camera being associated with the casing movably through an opening in the casing, the apparatus further comprising an actuator configured to move the camera through said opening between a retracted position in which the camera is arranged inside the casing and an extended position in which the camera extends at least partially outside the casing to acquire images, wherein the apparatus comprises a cover configured to reversibly close the opening when said camera passes from the extended position to the retracted position, the system including a control unit positioned at a distance with respect to the video-photographic apparatus, the control unit being operatively connected to the actuator so as to move the camera via the actuator between the extended position and the retracted position, the cover being configured to reversibly close the opening of the casing which the camera passes from the extended position to the retracted position.

20. The system according to claim 19, wherein the images are acquired on a sports field, the casing being buried in the sports field.
